(19) United States
(12) Patent Application Publication
(10) Pub. No.: US 2015/0047448 A1
(43) Pub. Date: Feb. 19, 2015

(54) GEAR

(71) Applicant: Johnson Electric S.A., Murten (CH)

(72) Inventors: Jing Ning TA, Hong Kong (CN); Zhi Guo WANG, Munich (DE); Qiu Mei LI, Shenzhen (CN); Yong Jun ZHAO, Shenzhen (CN)

(21) Appl. No.: 14/460,812

(22) Filed: Aug. 15, 2014

(30) Foreign Application Priority Data
Aug. 16, 2013 (CN) 201310359641.1

(51) Int. Cl. F16H 55/17

(52) U.S. Cl. CPC F16H 55/17
USPC 74/434

(57) ABSTRACT

A gear includes an inner ring portion, an outer ring portion, and a number of spokes connecting the inner ring portion with the outer ring portion. An outer circumferential surface of the outer ring portion is provided with teeth. Each spoke includes a curve-shaped main portion, an inner end section at an inner end of the main portion which connects to the inner ring portion, and an outer end section at an outer end of the main portion which connects to the outer ring portion. At least one of the inner end section and outer end section is formed with a furcated structure.

### CROSS REFERENCE TO RELATED APPLICATIONS

This non-provisional patent application claims priority under 35 U.S.C. §119(a) from Patent Application No. 201310359641.1 filed in The People's Republic of China on Aug. 16, 2014, the entire contents of which are hereby incorporated by reference.

### FIELD OF THE INVENTION

This invention relates to a gearbox and in particular, to a gear of a gearbox suitable for a window lift motor assembly of a vehicle.

### BACKGROUND OF THE INVENTION

Currently, manual vehicle window winders have been generally replaced by electric motor driven window lifts. The gear train is a key part of the electric window lift. Conventional window lift gear trains have output gears that can be generally classified into two categories: gears without rubber cushions and gears with rubber cushions. The gear without a rubber cushion is relatively simple in its overall design and has a small number of parts as well as low cost. However, the gear without a rubber cushion has a low anti-shock capability, high accuracy and high sensitivity, which results in increased vibrational friction and noise of the gear train during operation and thus an accelerated wear on the gears. On the other hand, while the gear with a rubber cushion can address the above problems, it has a complicated structure and a large number of parts. In addition, the gear with a rubber cushion has a problem of uneven rigidity when operating in a dual direction mode.

### SUMMARY OF THE INVENTION

Thus there is a desire for a gear which has a simplified structure, improved performance as well as reduced cost.

Accordingly, in one aspect thereof, the present invention provides a gear comprising an inner ring portion, an outer ring portion, and a plurality of spokes connecting the inner ring portion with the outer ring portion, an outer circumferential surface of the outer ring portion being provided with teeth, wherein each spoke comprises a curve-shaped main portion, an inner end section at an inner end of the main portion which connects to the inner ring portion, and an outer end section at an outer end of the main portion which connects to the outer ring portion, and at least one of the inner end section and outer end section is formed with a furcated structure.

Preferably, at least one of the inner end section and outer end section is furcated to form two branches, and the two branches are located at circumferentially opposite sides of the spoke.

Preferably, each of the inner end section and the outer end section is furcated to form two branches, and the two branches of the each of the inner end section and the outer end section are located at circumferentially opposite sides of the spoke.

Preferably, the main portion of the spoke is S-shaped.

Preferably, the plurality of spokes is uniformly distributed in a circumferential direction of the inner ring portion.

Preferably, the plurality of spokes is non-uniformly distributed in a circumferential direction of the inner ring portion.

Preferably, an axial height of the inner ring portion is greater than the axial height of the outer ring portion, and an outer circumferential surface of a part of the inner ring portion protruding beyond the outer ring portion is formed with teeth.

Preferably, the teeth of the outer ring portion are skew teeth, and the teeth of the inner ring portion are spur teeth.

Preferably, an axial height of the inner ring portion is greater than the axial height of the outer ring portion, the inner ring portion defines an axial through hole, and an inner surface of the axial through hole is formed with inner splines.

Preferably, the inner splines are spur teeth, and an axial height of the spur teeth is greater than an axial height of the outer ring portion.

Preferably, the gear further comprises a shaft sleeve body, an outer circumferential surface of the shaft sleeve body is provided with teeth, a flange and an inserting portion along an axial direction of the shaft sleeve body, the inserting portion of the shaft sleeve body is tight fit into the axial through hole of the inner ring portion, and a step is formed in an axial end of the inner ring portion for receiving the flange of the shaft sleeve body.

Preferably, the inserting portion of the shaft sleeve body is formed with outer splines, and the outer splines and the inner splines are spur teeth and engaged with each other.

Preferably, the flange of the shaft sleeve body is substantially flush with an end surface of the inner ring portion.

Preferably, the outer ring portion comprises an annular inner layer, an annular outer layer, and a connecting member connecting the annular inner layer with the annular outer layer, the teeth are formed on an outer circumferential surface of the annular outer layer, and the outer end sections of the spokes are connected to the annular inner layer.

Preferably, the connecting member comprises an annular piece and a plurality of plate-like pieces connected to the annular piece and the plate-like pieces are disposed respectively on opposite axial sides of the annular piece and disposed alternatively along a circumferential direction of the annular piece.

Preferably, the inner ring portion comprises an annular inner ring, an annular outer ring, and a connecting member connecting the annular inner ring with the annular outer ring, and the inner end sections of the spokes are connected to the annular outer ring.

Preferably, the connecting member includes an annular piece and a plurality of plate-like pieces connected to the annular piece, and the plate-like pieces are spaced apart from each other and perpendicular to a plane in which the annular piece is located.

Preferably, at least one axial side of each spoke is concave in an axial direction of the gear.

According to a second aspect thereof, the present invention provides an assembly comprising a motor and a gear train driven by the motor, the gear train comprising an output gear, wherein the output gear comprises an inner ring portion, an outer ring portion, and a plurality of spokes connecting the inner ring portion with the outer ring portion, an outer circumferential surface of the outer ring portion being provided with teeth, and wherein each spoke comprises a curved main portion, an inner end section at an inner end of the main portion which connects to the inner ring portion, and an outer end section at an outer end of the main portion which connects to the outer ring portion, and at least one of the inner end section and outer end section is formed with a furcated structure.

Preferably, the assembly includes a gear box having a housing fixed to the motor and accommodating the gear train, and a stationary shaft fixed to the housing, and the output gear is rotatably mounted on the stationary shaft.

Preferably, the output gear is a gear as described about.

The present invention can reduce the rigidity of the gear spoke, the noise of the gear as well as the vibration of the gear.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates a motor assembly for a car window lift in accordance with a preferred embodiment of the present invention;

FIG. 2 illustrates an output gear of the motor assembly of FIG. 1;

FIG. 3 is a plan view of the gear of FIG. 2;

FIG. 4 illustrates a gear main portion of a gear in accordance with another preferred embodiment of the present invention;

FIG. 5 illustrates a shaft sleeve portion of the gear of FIG. 4;

FIG. 6 is a sectional view of an assembly of the gear main portion and shaft sleeve portion of FIG. 4 and FIG. 5;

FIG. 7 is a sectional view of the gear main portion of FIG. 4; and

FIG. 8 illustrates a gear main portion of a gear in accordance with a further preferred embodiment of the present invention.

### DETAILED DESCRIPTION OF THE PREFERRED EMBODIMENTS

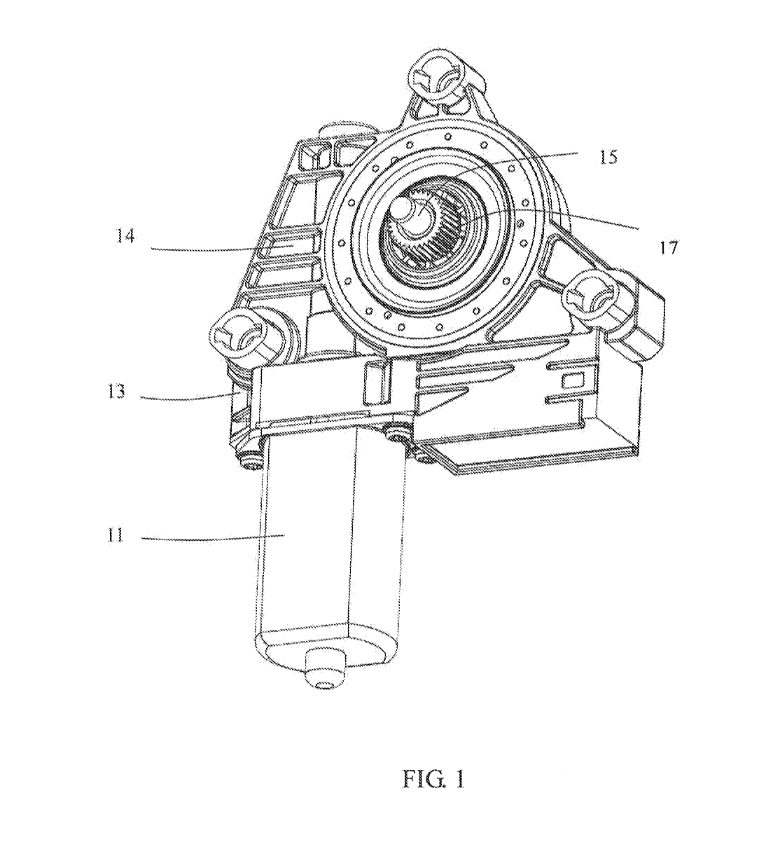

As shown in FIG. 1, a motor assembly for a vehicle window lift in accordance with a preferred embodiment of the present invention, includes a motor 11 and a gear box 13. The gear box 13 includes a housing 14, a stationary shaft 15 mounted to the outer housing 14, and a gear train including an output gear 17 rotatably mounted to the stationary shaft 15. A worm (not shown) is mounted on an output shaft of the motor 11 for driving the output gear 17, by means of which the rotational speed of the output is reduced.

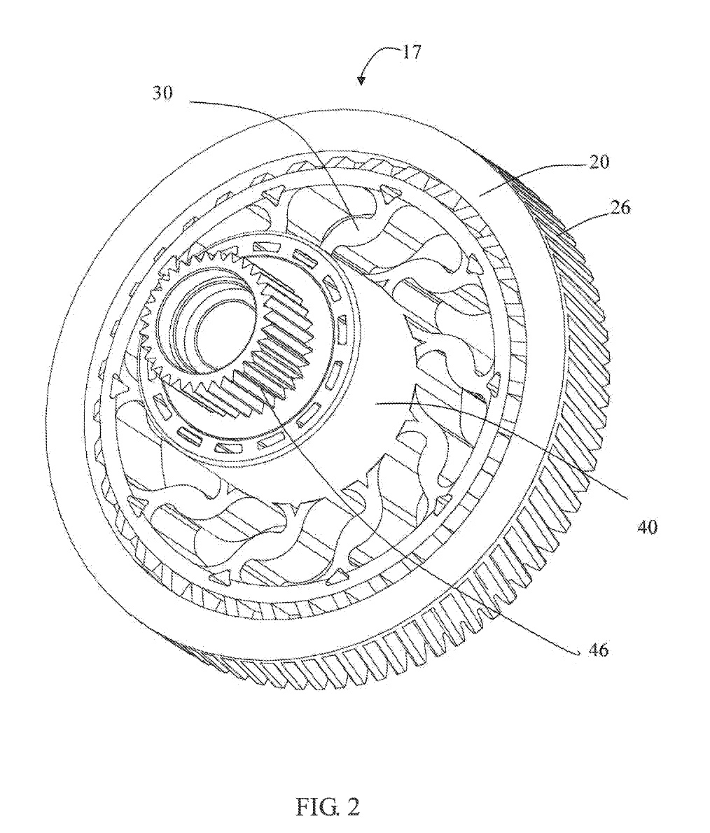

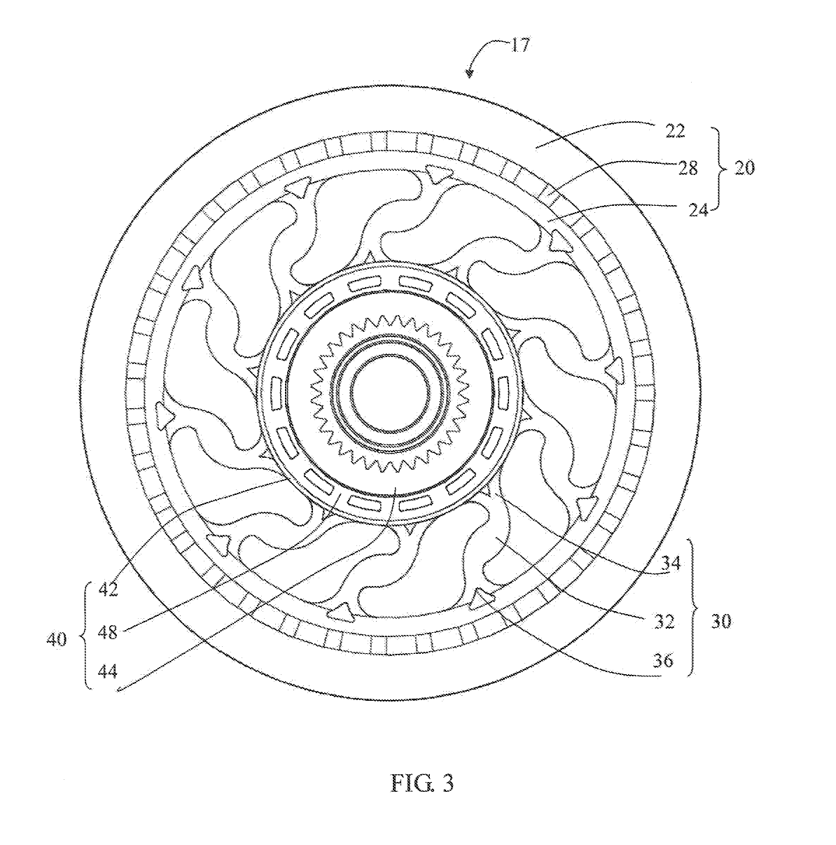

Referring to FIG. 2 and FIG. 3, the output gear 17 includes an outer ring portion 20 disposed in the housing, an inner ring portion 40 rotatably mounted on the stationary shaft and a plurality of spokes 30 connecting the inner ring portion 40 with the outer ring portion 20. An outer circumferential surface of the outer ring portion 20 is provided with teeth 26 which mate with the worm. An axial height of the inner ring portion 40 is greater than the axial height of the outer ring portion 20. The axial height of the inner ring portion 40 is preferably 1.8 to 4 times of that of the outer ring portion 20. An outer circumferential surface of a part of the inner ring portion 40 protruding beyond the outer ring portion 40 is formed with teeth 46 for driving the load. The spokes 30 and the outer ring portion 20 are substantially equal in axial height thus resulting in a flush end surface.

Each spoke 30 includes a main portion 32, an inner end section 34 at a radially inner end of the main portion 32 which connects to the inner ring portion 40, and a radially outer end section 36 at an outer end of the main portion 32 which connects to the outer ring portion 20. The main portion 32 is curved. In the illustrated embodiment, the projection of the main portion 32 on a plane perpendicular to the axial direction of the gear is S-shaped and symmetrical about its center point. A furcated structure is formed at each of the inner end section 34 and the outer end section 36. In the illustrated embodiment, each of the inner end section 34 and the outer end section 36 is furcated to form two branches, which are located on circumferentially opposite sides of the main portion 32. Ends of the branches respectively join with the inner ring portion 40 and outer ring portion 20. As a result, an opening is formed between each two branches and their corresponding inner ring portion 40 or outer ring portion 20, which can reduce stress concentration. The curved main portion 32 reduces the rigidity of the spoke 30 so that the gear bears the same stress and deformation during clockwise and counter-clockwise rotation of the gear, which facilitates reducing the noise and vibration of the gear. The presence of the branches at the inner end section 34 and the outer end section 36 further reduces the stress concentration as well as deformation of the gear.

It will be appreciated that the furcated structure can be formed only at the inner end section 34 or the outer end section 36 of the spoke 30. In addition, the main portion 32 of the spoke 30 may be of another shape other than S-shape or may not be symmetrical about its center point.

The outer ring portion 20 includes an annular inner layer 24, an annular outer layer 22, and a connecting member 28 connecting the annular inner layer 24 with the annular outer layer 28. The teeth 26 are formed on an outer circumferential surface of the annular outer layer 22. The outer end sections 36 of the spokes 30 are connected to the annular inner layer 24.

The inner ring portion 40 includes an annular inner ring 44, an annular outer ring 42, and a connecting member 48 connecting the annular inner ring 44 with the annular outer ring 42. The inner end sections 34 of the spokes 30 are connected to the annular outer ring 42.

In this embodiment, the teeth 26 of the outer ring portion 20 are skew teeth, and the teeth 46 of the inner ring portion 40 are spur teeth. It will be appreciated, however, that the teeth 26, 46 may be configured as skew teeth or spur teeth depending upon actual requirements.

The gear 17 illustrated above is integrally formed as a monolithic structure, preferably as a single piece plastic injection molding, which reduces the number of components. It will be appreciated, however, that the present invention is not intended to be limited to this particular embodiment.

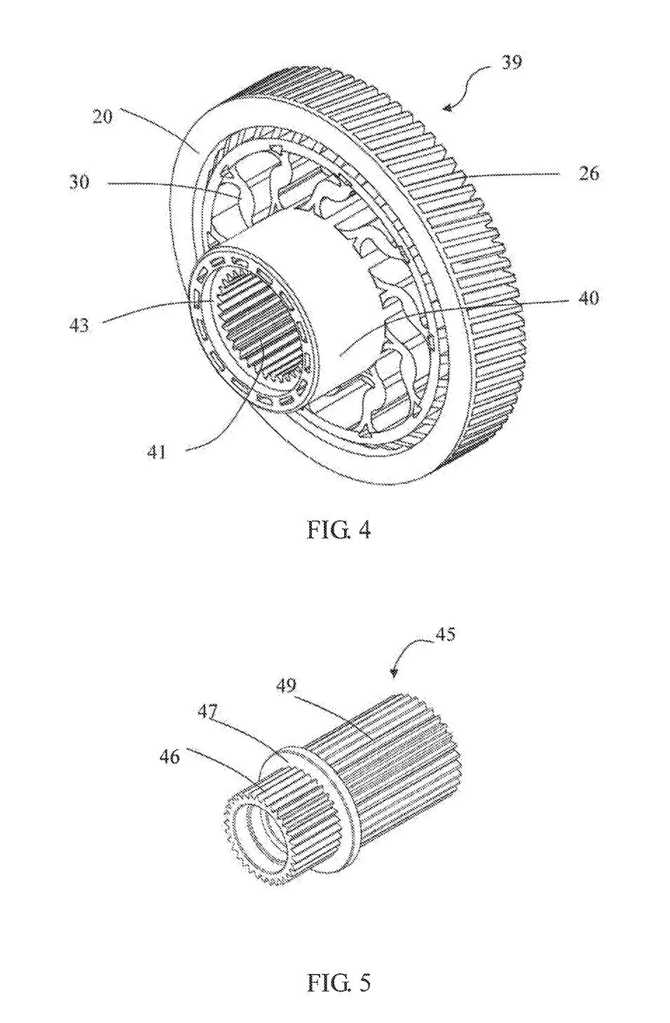

FIG. 4 to FIG. 7 illustrate another embodiment in which the gear is formed of separable parts. The gear in this embodiment includes a gear main body 39 (FIG. 4) and a shaft sleeve body 45 (FIG. 5). Referring to FIG. 4, the inner ring portion 40 defines an axial through hole 41, an inner surface of which is formed with inner splines for facilitating tight fit of the shaft sleeve body 45. In this embodiment, the inner splines are constructed as spur teeth, an axial height of which is greater than that of the outer ring portion 20. Preferably, the axial height of the inner ring portion 40 is 1.8 to 4 times of the outer ring portion 20.

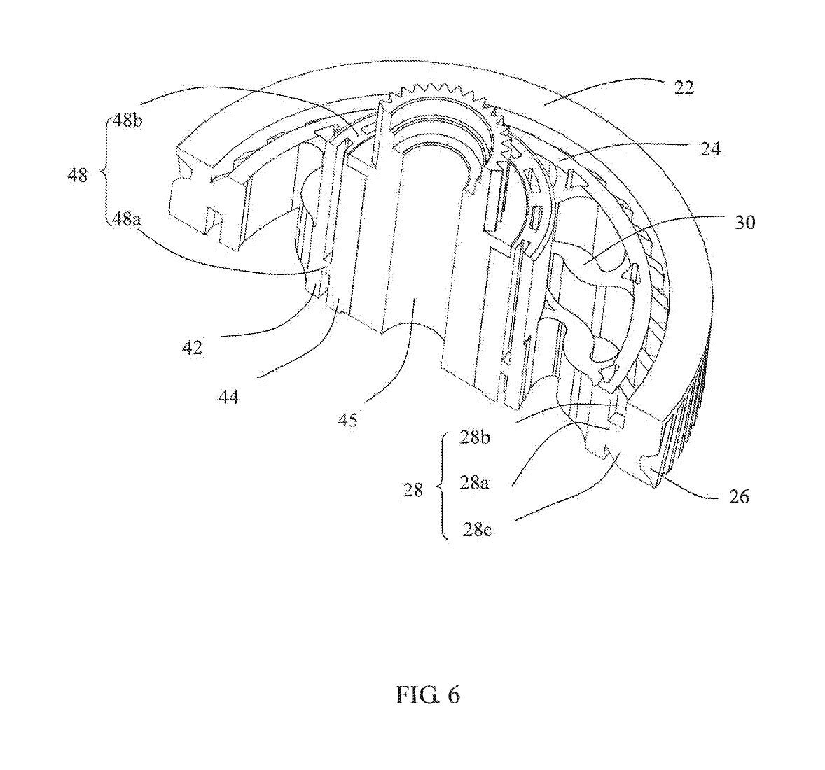

An outer circumferential surface of the shaft sleeve body 45 is provided with teeth 46, a flange 47 and an inserting portion 49, arranged in an axial direction of the shaft sleeve body 45. The inserting portion 49 of the shaft sleeve body 45 is a tight fit into the axial through hole 41 of the inner ring portion 40. The flange 47 abuts against a step 43 of the inner ring portion 40 and is flush with an end surface of the inner ring portion 40 (see FIG. 6). The step is formed in an axial end section of the inner ring portion 40 and leads to the through hole 41, for receiving the flange 47 of the shaft sleeve body 45.

In this embodiment, the inserting portion 49 of the shaft sleeve body 45 is formed with outer splines. The outer splines of the inserting portion 49 of the shaft sleeve body 45 mate with the inner splines of the through hole 41. Preferably, the two parts are made by injection molding plastic material and both splines are constructed as spur teeth, as this gives a join with good strength for the transfer of torque between the parts.

In this embodiment, the outer ring portion 20 includes an annular inner layer 24, an annular outer layer 22, and a connecting member 28 connecting the annular inner layer 24 with the annular outer layer 28. The teeth 26 are formed on an outer circumferential surface of the annular outer layer 22. The outer end sections 36 of the spokes 30 are connected to the annular inner layer 24. The connecting member 28 includes an annular piece 28a and a plurality of plate-like pieces 28b, 28c connected to the annular piece 28a. The plate-like pieces 28b, 28c are spaced apart from each other and extend in a direction perpendicular to a plane containing the annular piece 28a. In this embodiment, the plate-like pieces 28b and 28c are disposed respectively on opposite axial sides of the annular piece 28a and positioned alternately in the circumferential direction of the annular piece 28a.

The inner ring portion 40 includes an annular inner ring 44, an annular outer ring 42, and a connecting member 48 connecting the annular inner ring 44 with the annular outer ring 42. The inner end sections of the spokes 30 are connected to the annular outer ring 42. The connecting member 48 includes an annular piece 48a and a plurality of plate-like pieces 48b connected to the annular piece 48a and extending between the inner ring 44 and the outer ring 42. The plate-like pieces 48b are evenly spaced from each other in a circumferential direction of the annular piece 48a and are substantially perpendicular to a plane containing the annular piece 48a.

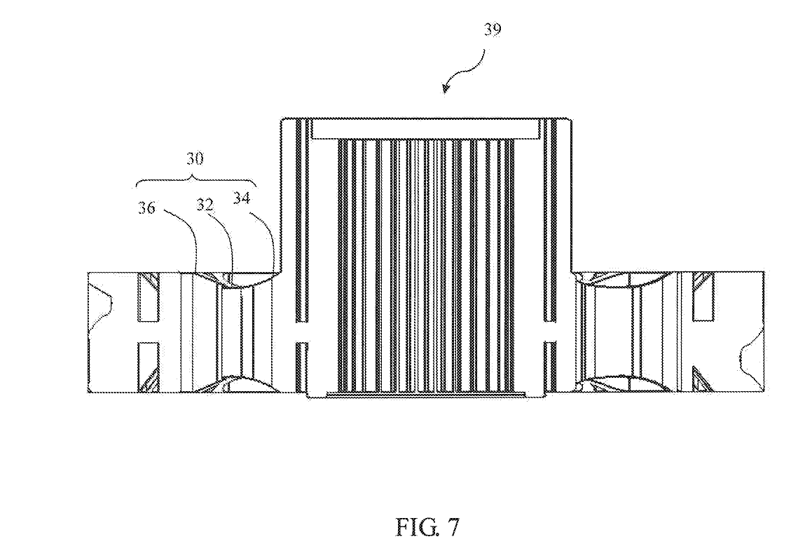

FIG. 7 illustrates an axial section of the gear main portion 39 of FIG. 4. The spoke 30 is shaped to have a reduced height, in the axial direction, at the center of the main portion 32 compared to the two end sections 34, 36. Preferably, the spoke 30 is concave in its axial end faces, at least in a middle part of the main portion 32. This design facilitates further reducing the noise. It will be appreciated that this design can be combined in other embodiments. For example, the integrally formed gear shown in FIG. 1 to FIG. 3 can also adopt this design. Preferably, the height of the spoke 30 changes gradually and smoothly.

In the above-mentioned embodiments, the spokes 30 are uniformly spaced in a circumferential direction of the inner annular portion 40. Referring to FIG. 3, the uniform spacing means that the spacing between adjacent spokes is substantially the same.

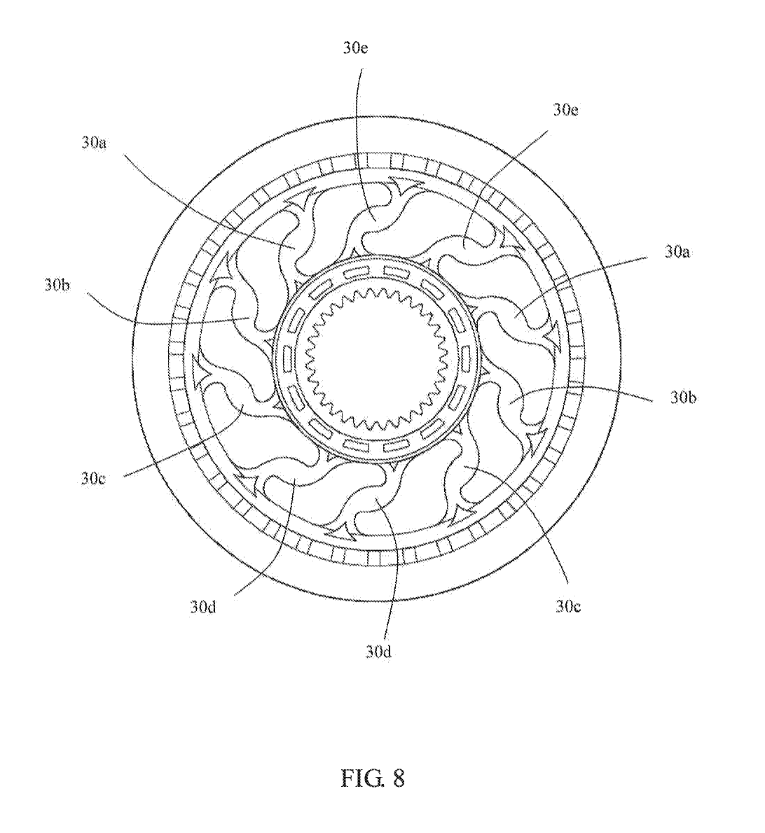

As an alternative, as shown in FIG. 8, the spokes 30 are non-uniformly distributed in the circumferential direction of the gear. That is, not all angles formed between adjacent spokes (the angle formed between lines each connecting the center point of one of the adjacent spokes and the center point of the gear) are the same. The angle formed between the two adjacent spokes 30a, 30b is equal to the angle formed between the two adjacent spokes 30b, 30c. The angle formed between the two adjacent spokes 30b, 30c is less than the angle formed between the two adjacent spokes 30c, 30d. In the embodiment of FIG. 8, there are two types of angles formed between the spokes, with one being a smaller angle formed, for example, the angles formed between spokes 30a, 30b, the angles formed between spokes 30b, 30c, the angles formed between the spokes 30a, 30e and the angle formed between the spokes 30d, and the other being a larger angle formed, for example, the angles formed between spokes 30c, 30d and the angle formed between spokes 30e. It is understood that the two types of angles may be alternately arranged. It will be appreciated that there may be more than two types of angles. For example, there may be three types of angles including a smaller angle, an intermediate angle, and a larger angle. Non-uniform distribution of the spokes can weaken or reduce the resonance effect thereby further reducing the noise.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Although the invention is described with reference to one or more preferred embodiments, it should be appreciated by those skilled in the art that various modifications are possible. Therefore, the scope of the invention is to be determined by reference to the claims that follow.

1. A gear comprising an inner ring portion, an outer ring portion, and a plurality of spokes connecting the inner ring portion with the outer ring portion, an outer circumferential surface of the outer ring portion being provided with teeth, wherein each spoke comprises a curve-shaped main portion, an inner end section at an inner end of the main portion which connects to the inner ring portion, and an outer end section at an outer end of the main portion which connects to the outer ring portion, and at least one of the inner end section and outer end section is formed with a furcated structure.

2. The gear of claim 1, wherein at least one of the inner end section and outer end section is furcated to form two branches, and the two branches are located at circumferentially opposite sides of the spoke.

3. The gear of claim 2, wherein each of the inner end section and the outer end section is furcated to form two branches, and the two branches of the each of the inner end section and the outer end section are located at circumferentially opposite sides of the spoke.

4. The gear of claim 1, wherein the main portion of the spoke is S-shaped.

5. The gear of claim 1, wherein the plurality of spokes is uniformly distributed in a circumferential direction of the inner ring portion.

6. The gear of claim 1, wherein the plurality of spokes is non-uniformly distributed in a circumferential direction of the inner ring portion.

7. The gear of claim 1, wherein an axial height of the inner ring portion is greater than the axial height of the outer ring portion, and an outer circumferential surface of a part of the inner ring portion protruding beyond the outer ring portion is formed with teeth.

8. The gear of claim 7, wherein the teeth of the outer ring portion are skew teeth, and the teeth of the inner ring portion are spur teeth.

9. The gear of claim 1, wherein an axial height of the inner ring portion is greater than the axial height of the outer ring portion, the inner ring portion defines an axial through hole, and an inner surface of the axial through hole is formed with inner splines.

10. The gear of claim 9, wherein the inner splines are spur teeth, and an axial height of the spur teeth is greater than an axial height of the outer ring portion.

11. The gear of claim 9, wherein the gear further comprises a shaft sleeve body, an outer circumferential surface of the shaft sleeve body is provided with teeth, a flange and an inserting portion along an axial direction of the shaft sleeve body, the inserting portion of the shaft sleeve body is tight fit into the axial through hole of the inner ring portion, and a step is formed in an axial end of the inner ring portion for receiving the flange of the shaft sleeve body.

12. The gear of claim 11, wherein the inserting portion of the shaft sleeve body is formed with outer splines, and the outer splines and the inner splines are spur teeth and engaged with each other.

13. The gear of claim 11, wherein the flange of the shaft sleeve body is substantially flush with an end surface of the inner ring portion.

14. The gear of claim 1, wherein the outer ring portion comprises an annular inner layer, an annular outer layer, and a connecting member connecting the annular inner layer with the annular outer layer, the teeth are formed on an outer circumferential surface of the annular outer layer, and the outer end sections of the spokes are connected to the annular inner layer.

15. The gear of claim 14, wherein the connecting member comprises an annular piece and a plurality of plate-like pieces connected to the annular piece and the plate-like pieces are disposed respectively on opposite axial sides of the annular piece and disposed alternatively along a circumferential direction of the annular piece.

16. The gear of claim 1, wherein the inner ring portion comprises an annular inner ring, an annular outer ring, and a connecting member connecting the annular inner ring with the annular outer ring, and the inner end sections of the spokes are connected to the annular outer ring.

17. The gear of claim 16, wherein the connecting member includes an annular piece and a plurality of plate-like pieces connected to the annular piece, and the plate-like pieces are spaced apart from each other and perpendicular to a plane in which the annular piece is located.

18. The gear of claim 1, wherein at least one axial side of each spoke is concave in an axial direction of the gear.

19. An assembly comprising a motor and a gear train driven by the motor, the gear train comprising an output gear,
wherein the output gear comprises an inner ring portion, an outer ring portion, and a plurality of spokes connecting the inner ring portion with the outer ring portion, an outer circumferential surface of the outer ring portion being provided with teeth, and
wherein each spoke comprises a curved main portion, an inner end section at an inner end of the main portion which connects to the inner ring portion, and an outer end section at an outer end of the main portion which connects to the outer ring portion, and at least one of the inner end section and outer end section is formed with a furcated structure.

20. The assembly of claim 19, further comprising a gear box having a housing fixed to the motor and accommodating the gear train, and a stationary shaft fixed to the housing, wherein the output gear is rotatably mounted on the stationary shaft.
